(19) United States
(12) Patent Application Publication
(10) Pub. No.: US 2019/0264588 A1
(43) Pub. Date: Aug. 29, 2019

(54) Transmission Assembly

(71) Applicant: Ford Global Technologies, LLC, Dearborn, MI (US)

(72) Inventors: Vladimir Yasnogorodskiy, Sterling Heights, MI (US); Lev Pekarsky, West Bloomfield, MI (US); David P. Aeschliman, Whitmore Lake, MI (US)

(21) Appl. No.: 15/903,077

(22) Filed: Feb. 23, 2018

(51) Int. Cl. F01M 11/00; F01M 11/03; F16H 57/04; B01D 35/147; B01D 35/027

(52) U.S. Cl. CPC F01M 11/0004; F01M 11/03; F01M 2011/0058; B01D 35/1475; B01D 35/0276; F16H 57/0404

(57) ABSTRACT

During assembly of a transmission, an adapter is installed on a transmission suction filter. The adapter includes a deformable bellows. A top lip of the bellows is attached to the filter inlet while a bottom lip of the bellows includes at least one fin. The fin has a chamfered edge. As two case halves are brought together, the chamfer rubs against a rear case half compressing the bellows. After assembly, the fins control a distance between a sump bottom and the bottom lip of the bellow. As a result, the fluid level can be lower without risking air ingestion.

### TECHNICAL FIELD

This disclosure relates to the field of transmission systems. More particularly, the disclosure pertains to a transmission utilizing an adapter to control the spacing between a sump bottom and a pump inlet.

### BACKGROUND

Automatic transmission fluid serves many functions in a modern automatic transmission. Pressurized fluid may be used to engage friction clutches in order to establish a power flow path with a desired speed ratio. Fluid lubricates gears and bearings. Excess heat is removed by fluid flowing over various components. When the fluid contains contaminants, it may be less effective in these functions and may cause failures such as stuck valves. Therefore, transmissions often include fluid filters. The fluid typically drains to a sump due to gravity. A transmission pump draws fluid from the sump and delivers pressurized fluid to a valve body, which distributes the fluid to various places within the transmission at pressures appropriate to the various functions.

### SUMMARY OF THE DISCLOSURE

A transmission includes first and second housings, a pump assembly, and an adapter. The pump assembly is supported by the first housing. The pump assembly may include a suction filter. The pump assembly has an inlet separated from an interior surface of the second housing by a distance. The adapter includes a deformable bellows and a fin. The bellows connects the inlet to the fin. The adapter has a free length, measured between the inlet and a tip of the fin, that is greater than the distance. The fin is chamfered on an edge opposite the first housing. The first and second housings may define a sump filled with fluid such that deformable bellows penetrates a surface of the fluid, placing the bellows inlet below the fluid surface.

A method of assembling a transmission includes attaching a pump to a first transmission case half, attaching a bellows to an inlet of the pump, and bringing the first transmission case half together with a second transmission case half. Attaching the bellows to the pump inlet may include attaching a filter between the pump inlet and the bellows. An end of the bellows opposite the inlet is fixed to a fin. As the transmission case halves are brought together, the second case half rubs against a chamfered edge of the fin to compress the bellows. The case halves may be sealed to one another to define a sump, which is then filled with fluid.

A transmission suction filter adapter includes a deformable bellows and a chamfered fin. The bellows has a top lip and a bottom lip. The top lip is configured to seal against a suction filter inlet. The bottom lip is fixed to the chamfered fin. The chamfered fin is configured to space the bottom lip away from a sump bottom. The chamfer is configured to compress the bellows in response to installation of the sump bottom along a direction parallel to a plane of the bottom lip.

### BRIEF DESCRIPTION OF THE DRAWINGS

FIG. 1 is a schematic diagram of a vehicle transmission.

FIG. 2 is a cross sectional view of a first transmission fluid intake system.

FIG. 3 is a cross sectional view of a second transmission fluid intake system utilizing a filter inlet adapter.

FIG. 4 is a flow chart for assembling the transmission fluid intake system of FIG. 3.

FIG. 5 is a cross sectional view illustrating a step in the process of FIG. 4.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

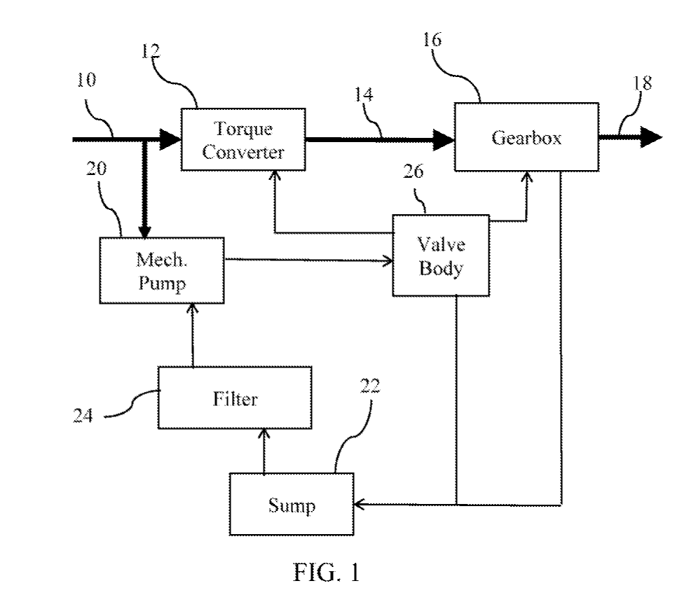

FIG. 1 schematically illustrates a transmission hydraulic system. Bold lines indicate mechanical power flow. Thin solid lines indicate flow of hydraulic fluid. Transmission input shaft 10 is connected to a power source such as a crankshaft of an internal combustion engine. Power is delivered to torque converter 12 which drives turbine shaft 14. Clutches within gearbox 16 are engaged to establish a power flow path from turbine shaft 14 to output shaft 18. Different power flow paths having different speed ratios may be established by engaging different clutches. In a rear wheel drive transmission, output shaft 18 is connected to a driveshaft which transmits the power to a rear differential and then to rear wheels. In a four wheel drive vehicle, a transfer case may be installed between the output shaft and the driveshaft to divert a portion of the power to a front differential and then to front wheels. In a front wheel drive vehicle, the output shaft may transmit power to a front differential via gears or a chain.

Some engine power is diverted to drive mechanical pump 20. Mechanical pump 20 draws fluid from sump 22, through filter 24, and delivers the fluid, at increased pressure, to valve body 26. The pressure at which fluid enters the valve body may be called line pressure. A network of control valves within the valve body deliver fluid to torque converter and gearbox components at desired pressures less than line pressure and at desired flow rates. Fluid drains from the control valves and from the gearbox back into sump 22.

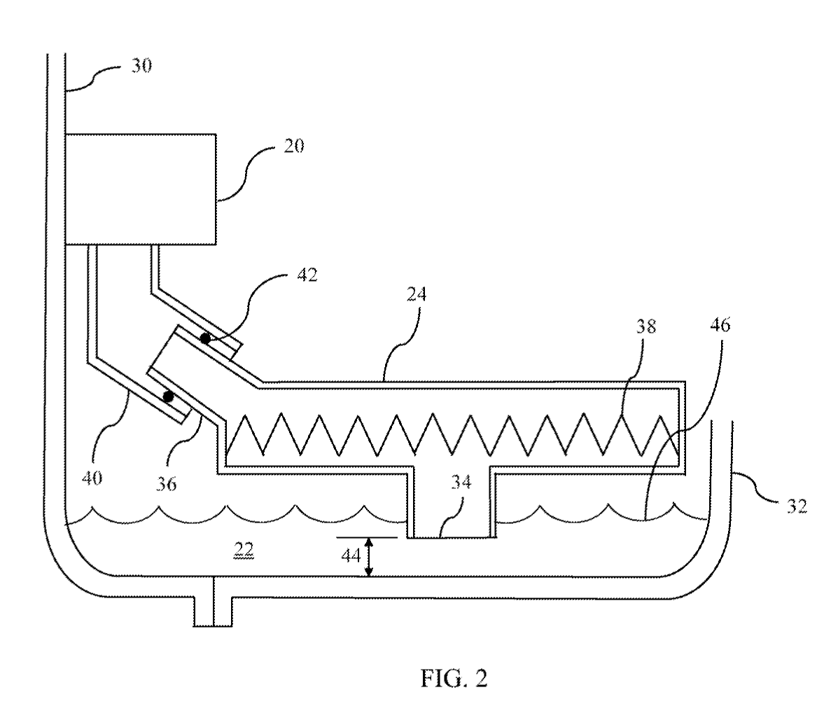

FIG. 2 is a cross section of a portion of a transmission assembly including pump 20, sump 22, and filter 24. Sump 22 is formed by joining together a front case half 30 and a rear case half 32. Pump 20 is supported by front case half 30. Filter 24 includes an inlet 34, an outlet tube 36, and filter media 38. Filter outlet tube 36 is sealed to pump inlet tube 40 by a seal 42. Fluid flows from the sump 22, through filter inlet port 34, through filter media 38, through filter outlet tube 36, through pump inlet tube 40, into pump 20.

The vertical distance 44 between the bottom of the sump and the entry point of fluid into the pump system is critical to system performance. If this distance is too small, it excessively constrains the flow of fluid. If the distance is too large, then air may be ingested into the pump system whenever fluid sloshes fore and aft or side to side due to vehicle acceleration or deceleration. To avoid air ingestion, the quantity of fluid in sump 22 is set such that the top surface 46 of the fluid is far enough above the entry point of fluid into the pump system. If the top surface 46 of the fluid is too high, rotating components will be partially submerged resulting in significantly higher parasitic drag and reduced fuel economy.

Controlling distance 44 is difficult in practice because a number of sources of variability add up. In addition to variability of the individual parts, the distance is impacted by variability in the joints between case halves, between the front case half and the pump, and between the pump and the filter. Variation of the vertical distance 44 between the bottom of the sump and the fluid entry point exacerbates the problems of ensuring adequate flow, avoiding air ingestion, and reducing parasitic drag. The nominal value of distance 44 must be set to ensure that the minimum distance at worst case tolerance stack-up provides sufficient flow. To avoid air ingestion, the fluid level must be set based on the maximum distance at another worst case tolerance stack-up.

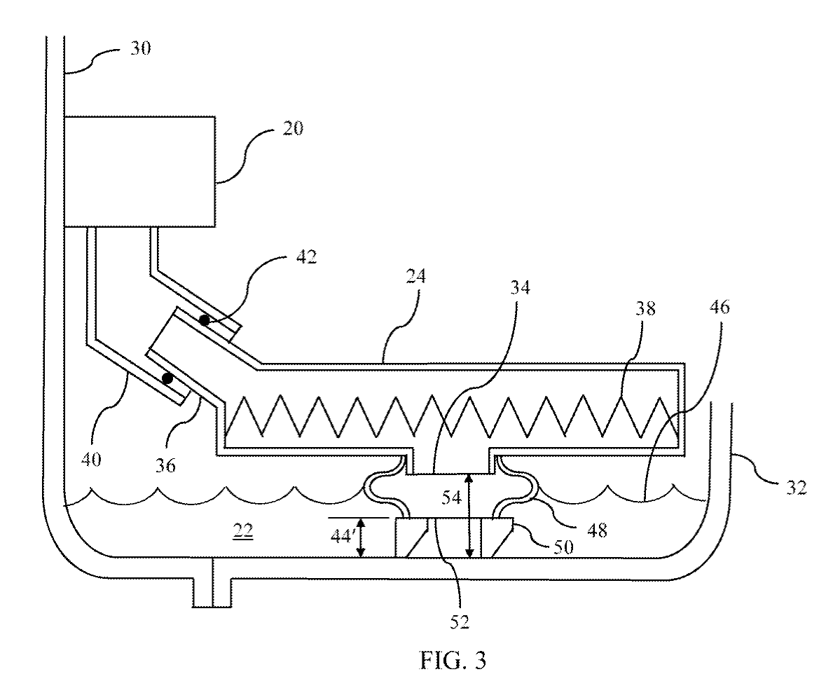

FIG. 3 is a cross section of the same portion of the transmission cross section as FIG. 2 wherein the filter 24 includes an adapter which facilitates controlling the critical dimension 44′. The adapter includes a deformable bellows 48 and at least one fin 50. A top end of the deformable bellows is sealed around filter inlet 34. The bottom end 52 of the deformable bellows is attached to fins 50. The bellows act as a compression spring, forcing the fins into contact with an interior surface of rear case half 32. Fluid flows from the sump 22, through bellows 48, through filter inlet port 34, through filter media 38, through filter outlet tube 36, through pump inlet tube 40, into pump 20. In this embodiment, the critical distance 44′ is between the bellows inlet 52 and the bottom of the sump. Since the fins contact the sump bottom, this critical dimension is directly related to the dimensions of the fins and is much easier to control accurately than the critical dimension of the embodiment of FIG. 2. The vertical distance 54 between the filter inlet 34 and the sump bottom is greater than the distance 44′. The nominal distance 44′ is also less than the nominal distance 44 of FIG. 2 permitting the fluid level to be lower without risking air entrainment.

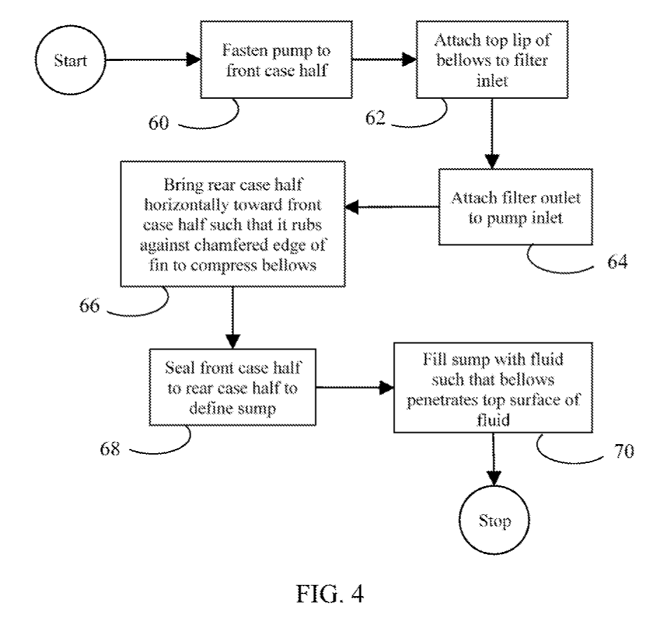

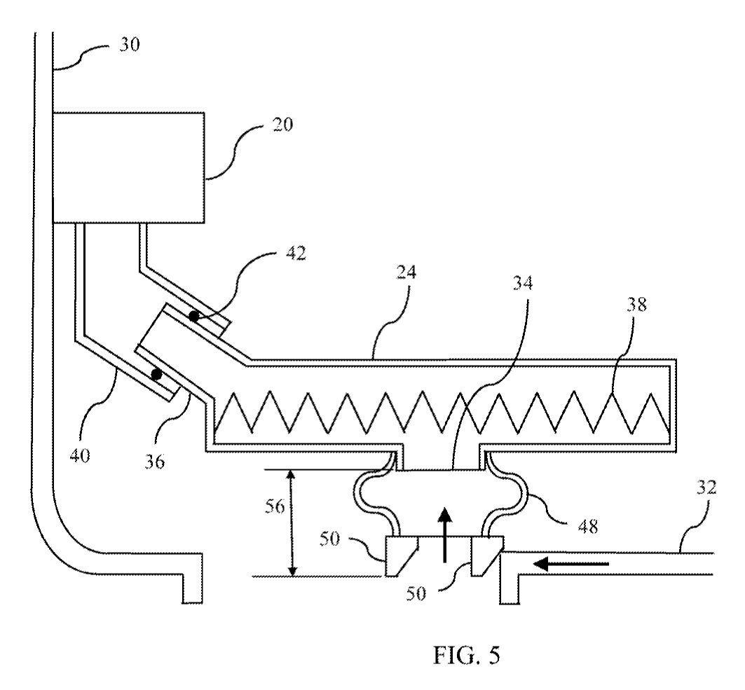

FIG. 4 is a flow chart illustrating a process of assembling the transmission of FIG. 3. At 60, pump 20 is fastened to front case half 30. At 62, the top lip of bellows 48 is fastened around the inlet 34 of filter 24. At 64, outlet 36 of filter 24 is attached to inlet 40 of pump 20. At 66, rear case half 32 is brought horizontally toward front case half 30. It may be necessary to bring the case halves together horizontally for rear case half to clear gearbox components that are not shown in FIGS. 2 and 3. This step is further illustrated in FIG. 5. Before this step, the adapter has a free (neither compressed nor stretched) length 56 between the filter inlet and a tip of a fin. As the rear case half is brought forward, it rubs against a chamfered edge of at least one of the fins. In response, the bellows compresses. After the case halves are brought together, they are sealed at 68 to form the sump. At 70, the sump is filled with fluid such that the bellows penetrates the top surface of the fluid. (The bellows may become completely immersed.)

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, embodiments described as less desirable than other embodiments or prior art implementations with respect to one or more characteristics are not outside the scope of the disclosure and can be desirable for particular applications.

What is claimed is:

1. A transmission comprising:
first and second housings;
a pump assembly supported by the first housing and having an inlet separated from an interior surface of the second housing by a distance; and
an adapter having a deformable bellows connecting the inlet to a fin, the adapter having a free length between the inlet and a tip of the fin that is greater than the distance, the fin chamfered on an edge opposite the first housing.

2. The transmission of claim 1 wherein the pump assembly comprises a filter.

3. The transmission of claim 1 wherein the first and second housings define a sump.

4. The transmission of claim 3 further comprising fluid in the sump such that the deformable bellows penetrates a surface of the fluid.

5. The transmission of claim 3 further comprising fluid in the sump such that the deformable bellows is completely immersed in the fluid.

6. A method of assembling a transmission comprising:
attaching a pump to a first transmission case half;
attaching a bellows to an inlet of the pump, an end of the bellows opposite the inlet fixed to a fin; and
bringing the first transmission case half together with a second transmission case half such that the second case half rubs against a chamfered edge of the fin to compress the bellows.

7. The method of claim 6 wherein attaching the bellows to the inlet of the pump comprises:
directly attaching an outlet of a filter to the inlet of the pump; and
directly attaching a top lip of the bellows to an inlet of the filter.

8. The method of claim 6 further comprising:
sealing the first transmission case half to the second transmission case half to define a sump; and
filling the sump with fluid to a level such that the bellows inlet is below a surface of the fluid.

9. The method of claim 8 further comprising filling the sump with additional fluid to a level such that the bellows is immersed in the fluid.

10. A transmission suction filter adapter, comprising:
a deformable bellows having a top lip and a bottom lip, the top lip configured to seal against a suction filter inlet; and
a first chamfered fin fixed to the bottom lip and configured to space the bottom lip away from a sump bottom and to compress the bellows in response to installation of the sump bottom along a direction parallel to a plane of the bottom lip.

11. The transmission suction filter adapter of claim 10 further comprising a second chamfered fin fixed to the bottom lip.
